(19) United States
(12) Patent Application Publication
(10) Pub. No.: US 2004/0094486 A1
(43) Pub. Date: May 20, 2004

(54) Use of polymers as filtering aids and/or stabilizers

(76) Inventors: Christian Drohmann, Schifferstadt (DE); Helmut Witteler, Wachenheim (DE); Axel Sanner, Frankenthal (DE); J?uuml;rgen Ziehl, Limburgerhof (DE); Elisa Hamm de Bantleon, M?uuml;nchen (DE); Tobias Petsch, M?ouml;rschied (DE); Klemens Mathauer, Heidelberg (DE); Barabara Lebtig, Ilsfeld (DE)

Correspondence Address: KEIL & WEINKAUF, 1350 CONNECTICUT AVENUE, N.W., WASHINGTON, DC, 20036, US

(21) Appl. No.: 10/398,179

(22) PCT Filed: Oct. 13, 2001
(86) PCT No.: PCT/EP01/11861

(30) Foreign Application Priority Data
Oct. 16, 2000 (DE) 10051266.6

(51) Int. Cl. B01D 37/02

(52) U.S. Cl. 210/777

(57) ABSTRACT

The use of polystyrene-containing polymers as filter aids and/or stabilizers for the filtration or stabilization of aqueous liquids, and also novel particulate polymers which are insoluble in water and scarcely swellable are claimed.

The present invention relates to the use of polystyrene-containing polymers as filter aids and/or stabilizers for the filtration or stabilization of aqueous liquids, and also to novel particulate polymers which are insoluble in water and scarcely swellable.

Separation of solid-liquid mixtures of substances by filtration is an important process step in many industrial production processes. The term filter aid encompasses a number of products which are used in bulk, pulverulent, granulated or fibrous form as precoat material in filtration.

Filter aids can be applied, before the start of filtration, as an auxiliary filter layer (precoat filter) to the filter aid [sic], to achieve a looser cake structure, or can be added continuously to the slurry to be filtered.

Known filter additives are, for example, diatomaceous earths, natural products resulting from the calcination of diatomite. The main constituents are amorphous SiO₂ modifications, accompanied by oxides of aluminum, iron and other elements, and also their silicate compounds. Perlites are calcined, ground and selected expanded clays of volcanic origin (rhyolites). Their structure may be described as leaflet-like and chemically as a sodium, potassium, aluminum silicate. Bentonites are clay minerals having high swelling capacity and absorption capacity.

Filter aids should, during filtration, form a porous environment which takes up the impurities to be eliminated and facilitates the outflow of the liquid phase.

The additives should have an elevated porosity and should also not deform under the effect of pressure. In addition, the substances should be chemically inert and easily recoverable.

For filtering beer, currently predominantly kieselguhr precoat filters and depth filters are used. In precoat filtration, before the start of filtration, a kieselguhr precoat is applied to a support surface (filter cloth). After this precoat is applied, a mixture of fine and coarse kieselguhr is added to the beer to be filtered (filter feed). In the production of beer, a kieselguhr consumption of from 150 to 200 g/h1 of beer must be expected. Kieselguhr is particularly proven for precoat filtration because of its high pore volume, its low bulk density, its high absorption capacity and its high specific surface area.

A disadvantage of the use of kieselguhr is that after a number of filtration operating hours its effectiveness is exhausted due to retained solids material and it must be removed from the filter support surfaces and replaced.

Landfilling exhausted kieselguhr, owing to legal prescriptions, is only possible with great difficulty and costs. Attempts to regenerate the kieselguhr which is unusable as filter material have proved not to be feasible in practice. In addition, kieselguhr has been under discussion for some time because of its possible carcinogenic activity.

The removal of substances causing haze, such as dissolved polyphenols or proteins, is an important process step in many beverage production processes, because the removal of these substances leads to a longer shelf life of the beverages.

The beverages can be stabilized by adding substances which bind or precipitate the haze-forming substances, or otherwise remove them from the medium in a suitable manner. These substances include, for example, silica gel, which binds or precipitates proteins, or polyvinylpyrrolidone, which binds polyphenols.

Filter aids and stabilizers have previously been used separately or together. In the first case, however, this means increased equipment requirements, and in the second case the joint disposal is a problem, in addition, in the case of the substances previously used, it is not possible to regulate the absorption.

EP 351 363 describes highly crosslinked polyvinylpolypyrrolidones (PVPP) as stabilizers and filter aids. However, when polyvinylpolypyrrolidone is used alone, it is difficult to adjust the absorption.

U.S. Pat. No. 4,344,846 describes a method for precoat filtration using filter aids based on expanded polystyrene.

WO 96/35497 describes regenerable filter aids for filtering a liquid medium, in particular beer, which comprise granules of synthetic or natural polymers that form a filter cake having a porosity between 0.3 and 0.5.

It is an object of the present invention to provide a filter aid and stabilizer which can be used instead of kieselguhr in the filtration or stabilization of aqueous liquids, in particular in beer and beverage production. It should be usable both solely as a filter aid and as a stabilizer as well as for both functions at the same time. It should be insoluble and scarcely swellable, chemically inert and of high surface area, and should be simple to produce in acceptable reaction times. In addition, it should be possible to set the absorption in a targeted manner and it should be regenerable.

We have found that this object is achieved according to the invention by a filter aid comprising polystyrene and at least one further additive.

The invention relates to the use of polymers comprising

a) 20-95% by weight of polystyrene

b) 80-5% by weight of at least one further substance selected from the group consisting of silicates, carbonates, oxides, silica gel, kieselguhr, diatomaceous earth, other polymers or mixtures thereof

as a filter aid and/or stabilizer for filtering and/or stabilizing an aqueous liquid.

The invention further relates to a process for filtering and/or stabilizing an aqueous liquid, which comprises using as filter aid or stabilizer a polymer comprising

(a) 20-95% by weight of polystyrene

(b) 80-5% by weight of at least one further substance selected from the group consisting of silicates, carbonates, oxides, silica gel, kieselguhr, diatomaceous earth, other polymers or mixtures thereof.

The process can be carried out in such a manner that in each case only filtration or stabilization of the aqueous medium takes place, or, in addition to the filtration, simultaneous stabilization takes place. Preferably, in addition to the filtration, stabilization also takes place.

During the filtration the precoat filtration technique is preferably used.

The invention also relates to a polymer comprising

a) from 20 to 95% by weight of polystyrene

b) 80-5% by weight of crosslinked polyvinylpolypyrrolidone (PVPP) with or without other additives.

The invention also relates to its use as filter aid and/or stabilizer, and to a process for its preparation.

Surprisingly, by means of the inventive polymers, the absorption, for example, of the constituents causing haze in beverages may be adjusted in a targeted manner.

If, for example, in the case of beer, the polyphenols present therein are completely removed, the beer also loses by this means its flavor compounds.

A further advantage of the use of the inventive polymers is their regenerability.

For the purposes of the invention the polystyrene derivatives specified under (a) are polystyrenes which can be unsubstituted or substituted by organic radicals such as alkyl, aryl, alkylaryl, cycloalkyl or alkoxy and/or can be substituted by functional groups such as basic groups, for example amino groups, acid groups, for example sulfonic acid groups, or their conjugates, for example ammonium groups, sulfonates, carboxylates, which can be on the aromatic styrene ring or the organic radicals.

For the purposes of the invention the term “polystyrenes” is the entire group of “styrene polymers” as described in A. Echte; Handbuch der Technischen Polymerchemie [Handbook of Industrial Polymer Chemistry]; VCH, Weinheim, 1993. This definition comprises a group of thermoplastic materials: homopolystyrene, copolymers of styrene, especially with acrylonitrile, but also with maleic anhydride, methyl methacrylate and similar comonomers, and their modified derivatives toughened with rubbers.

The polystyrenes (a) are used in the context of the invention in amounts of 20-95% by weight, preferably 40-90% by weight, in particular preferably 60-90% by weight, based on the total amount of the filter aid.

For the purposes of the present invention, carbonates under (b) are alkali metal carbonates or alkaline earth metal carbonates, alkali metal hydrogencarbonates or alkaline earth metal hydrogencarbonates, preferably calcium carbonate, sodium hydrogencarbonate or potassium hydrogencarbonate. The oxides are oxides or mixtures of subgroup 4 or main group 3 of the Periodic Table of the Elements, preferably titanium oxide or aluminum oxide.

Silicates are miscellaneous natural and artificial silicates not explicitly specified above; these also include mixed silicates such as aluminosilicates or else zeolites.

Other polymers under (b) used are preferably polyamide or crosslinked polyvinyllactam and/or polyvinylamine. Polyvinyllactam and/or polyvinylamine preferably used are: polyvinylpyrrolidone, polyvinylpiperidone, polyvinylcaprolactam, polyvinylimidazole, polyvinyl-2-methylimidazole, polyvinyl-4-methylimidazole, polyvinylformamide. Particularly preferably, highly crosslinked polyvinylpolypyrrolidone for example that obtained under the tradename Divergan® F is used.

This is customarily obtained by what is termed popcorn polymerization. This is a polymerization method in which the growing polymer chains are crosslinked to one another. This can take place in the presence or absence of a crosslinker.

Crosslinkers are compounds which contain at least two ethylenically unsaturated non-conjugated double bonds in the molecule. Preferred crosslinkers are divinylbenzene, N,N′-divinylethyleneurea, N,N′-divinylpropylurea, alkylenebisacrylamides, alkylene glycol di(meth)acrylates.

The end product of popcorn polymerization is a foamed, crusty, granular polymer having a cauliflower-like structure. Because of their generally high degree of crosslinking, popcorn polymers are generally insoluble and scarcely swellable.

The additives specified under (b) can be present in the filter aid either alone or else in mixtures. Additives used alone are preferably crosslinked polyvinylpyrrolidone, TiO₂, KHCO₃, NaHCO₃, CaCO₃, silica gel, kieselguhr, diatomaceous earth or bentonite. Preferably, mixtures of crosslinked polyvinylpolypyrrolidone (PVPP) with TiO₂, NaHCO₃, KHCO₃, CaCO₃, silica gel, kieselguhr, diatomaceous earth or bentonite, or mixtures of NaHCO₃ or KHCO₃ with CaCO₃, TiO₂, silica gel, kieselguhr, diatomaceous earth or bentonite, or else mixtures of TiO₂ with NaHCO₃, KHCO₃, CaCO₃, silica gel, kieselguhr, diatomaceous earth or bentonite are used. Crosslinked polyvinylpolypyrrolidone is particularly preferably used.

The polystyrenes used can be prepared by processes known per se. Such processes are described, for example, in A. Echte; Handbuch der Technischen Polymerchemie [Handbook of Industrial Polymer Chemistry]; VCH, Weinheim, 1993.

To produce the polymer powders, polystyrene and at least one further substance are compounded in an extruder.

Compounding is generally mixing a polymer with at least one additive (Der Doppelschneckenextruder: Grundlagen-und Anwendungsgebiete [The double-screw extruder: Principles and areas of application], edited by: VDI-Gesellschaft Kunststofftechnik. -Düsseldorf : VDI-Verlag, 1995, Chapter 7 and Aufbereiten von Polymeren mit neuartigen Eigenschaften [Compounding polymers having novel properties], edited by: VDI-Gesellschaft Kunststofftechnik. -Düsseldorf : VDI-Verlag, 1995, pp. 135ff.). Compounding polymers by filling and reinforcing is carried out, for example, in the case of polyolefins and polystyrene for specific improvement in properties and to reduce the manufacturing costs. The fillers may be differentiated according to their particle geometry by the aspect ratio. If the value is less than ten, the substance is a pure filler (extender), and a reinforcing action is usually only achieved at higher values. This effect can be reinforced by pronounced adhesion forces between additive and polymer. Fillers frequently used are calcium carbonate (chalk) and talcum. Because of its approval for food, calcium-carbonate-filled polypropylene has also been widely used for food packages (injection molding, thermoforming). In addition, filling polypropylene with sawdust is described for sheets which are used in automobile construction. Other customary fillers are glass (for example in bead form), asbestos, silicates (for example wollastonite), mica, spars and graphite. A usual filler content is 20-80% by mass, but it can also be up to 95%. Reinforcing thermoplastics with fibrous substances increases the mechanical properties, in particular rigidity and hardness of the plastic. The fibers customarily used are glass fibers, carbon fibers, steel fibers and aramid fibers. By mixing at least two plastics, alloying, polymers having a different property profile are obtained. The mixtures can be homogeneous, heterogeneous or of partial or limited compatibility.

In all cases, the use of extruders, in particular twin-screw extruders is preferred. However, in addition, co-kneaders are also used.

Customarily, during extrusion, temperatures and pressures occur which, in addition to the purely physical mixing, can make chemical reaction possible, that is to say chemical change of the components used.

Reaction for the purposes of the invention is a process in which at least two substances are reacted physically and/or chemically with one another.

The reaction can also take place via customary processes for thermoplastics, in particular mixing, dispersing, filling, reinforcing, blending, degassing, and reactive compounding by rolling, kneading, casting, sintering, pressing, compounding, calandering, extrusion or combination of these methods. However, preferably, the polymer powders are compounded in an extruder.

For the purposes of the invention filtration is passing a suspension (slurry) consisting of a discontinuous phase (dispersed substances) and a continuous phase (dispersion medium) through a porous filter medium. During this operation solid particles are deposited on the filter medium and the filtered liquid (filtrate) leaves the filter medium in a clear state. The external force which acts to overcome the resistance to flow is an applied pressure difference.

In the filtration operation, in principle different mechanisms of solids separation can be observed. Principally, these are surface filtration or cake filtration, depth filtration and screening filtration. Frequently filtration involves a combination of at least two processes.

In the case of surface or cake filtration, what are termed precoat filters are used in various designs for beverage filtration (Kunze, Wolfgang, Technologie Brauer und Mälzer, 7^{th} edition, 1994, p. 372). All precoat systems share the fact that the solids present in the liquid to be filtered and also the solids which are deliberately added (filter aids) are retained by a filter medium, as a result of which a filter cake builds up. The suspension must flow through this in the course of filtration, in addition to the filter medium. A filtration of this type is also termed precoat filtration.

The liquids to be filtered and/or stabilized according to the invention are fruit juices or fermented beverages such as wine or beer. In particular, the inventive process is used for filtering and/or stabilizing beer.

The inventively prepared filter aids and stabilizers are distinguished by high wettability with water and constant flow rate with, at the same time, good filtration activity.

The filter aids are comminuted after the mixing process by techniques of pelletizing, shredding and/or grinding, preferably by a sequence of pelletizing and grinding. At the temperature profile of a cold grinding process, water may remain in the final product.

The resultant powders have a mean particle size from 1 to 1000 μm, preferably from 2 to 200 μm. They have either a regular or irregular structure which may be spheroidal or nonspheroidal. However, the resultant powders are preferably nonspheroidal.

The examples below are intended to describe the invention in more detail, but without restricting it thereto.

A) Production of Polymer Powders

Polystyrene and at least one further substance (total amount approximately 10 kg) are compounded in an extruder. The extrudate is cooled in a water bath and pelletized. The resultant pellets are comminuted in an impact disk mill and screened using a vibration tumble screen.

The weight ratios in which polystyrene and the respective additives (substance 1, where appropriate also substance 2) have been compounded is given by the table below. The sample identification is given in brackets after the weight ratio.

| | Substance | Substance | Ratio PS:Substance 1 |
|---|---|---|---|
| # | 1 | 2 | (where appropriate: Substance 2) |
| 1 | Kieselguhr | — | 20:80 (1a); 50:50 (1b); 80:20 (1c); |
| | | | 90:10 (1d) |
| 2 | CaCO₃ | — | 40:60 (2a); 60:40 (2b); 70:30 (2c); |
| | | | 80:20 (2d) |
| 3 | TiO₂ | — | 50:50 (3a); 60:40 (3b); 70:30 (3c); |
| | | | 80:20 (3d) |
| 4 | PVPP | — | 20:80 (4a); 40:60 (4b); 60:40 (4c); |
| | | | 70:30 (4d); 80:30 (4e); 90:10 (4f) |
| 5 | NaHCO₃ | — | 90:10 (5a); 95:5 (5b); 98:2 (5c); |
| | | | 99:1 (5d) |
| 6 | Silica gel | — | 50:50 (6a); 60:40 (6b); 80:20 (6c); |
| | | | 90:10 (6d) |
| 7 | Bentonite | — | 50:50 (7a); 60:40 (7b); 70:30 (7c); |
| | | | 80:20 (7d) |
| 8 | PVPP | TiO₂ | 50:40:10 (8a); 70:20:10 (8b) |
| 9 | PVPP | NaHCO₃ | 50:45:5 (9a); 80:18:2 (9b) |
| 10 | PVPP | CaCO₃ | 50:40:10 (10a); 70:20:10 (10b) |
| 11 | PVPP | Kieselguhr | 40:40:20 (11a); 60:20:20 (11b); |
| | | | 70:20:10 (11c) |
| 12 | PVPP | Silica gel | 70:25:5 (12a); 70:28:2 (12b) |
| 13 | CaCO₃ | NaHCO₃ | 70:25:5 (13a); 80:18:2 (13b) |
| 14 | CaCO₃ | Kieselguhr | 60:20:20 (14a); 80:10:10 (14b) |
| 15 | CaCO₃ | Silica gel | 70:20:10 (15a); 80:15:5 (15b) |
| 16 | TiO₂ | NaHCO₃ | 75:20:5 (16a); 78:20:2 (16b) |
| 17 | TiO₂ | Kieselguhr | 70:20:10 (17a); 80:10:10 (17b) |
| 18 | TiO₂ | Silica gel | 70:20:10 (18a); 80:15:5 (18b) |

In the table:
PS: polysterene 486M, BASF AG
Kieselguhr: kieselguhr, Merck, CAS No. 68855-54-9;
CaCO₃: calcium carbonate (precipitated, high-purity), Merck, CAS No. 471-34-1;
TiO₂: titanium dioxide (<325 mesh, 99%), Aldrich, CAS No. 1317-70-0;
PVPP: Divergan F, BASF, CAS No. 9003-39-8;
NaHCO₃: sodium hydrogencarbonate (high-purity), Merck, CAS No. 144-55-8;
Silica gel: silica gel, Merck, CAS No. 63231-67-4;
Bentonite: bentonite, Aldrich

In the table:

PS: polystyrene 486M, BASF AG

Kieselguhr: kieselguhr, Merck, CAS No. 68855-54-9;

CaCO₃: calcium carbonate (precipitated, high-purity), Merck, CAS No. 471-34-1;

TiO₂: titanium dioxide (<325 mesh, 99%), Aldrich, CAS No. 1317-70-0;

PVPP: Divergan F, BASF, CAS No. 9003-39-8;

NaHCO₃: sodium hydrogencarbonate (high-purity), Merck, CAS No. 144-55-8;

Silica gel: silica gel, Merck, CAS No. 63231-67-4;

Bentonite: bentonite, Aldrich

B) Application Tests

a) Sedimentation in Water

For use in precoat filtration, sedimentation of the material envisaged as filter aid in the corresponding liquid to be filtered and/or in the liquid used for the precoat application (customarily water) is advantageous. A suitable test is the sedimentation behavior in water.

| Material | Sedimentation in water |
|---|---|
| Kieselguhr¹⁾ | Yes |
| Polystyrene¹⁾ | No |
| Material 1a | Yes |
| Material 1c | Yes |
| Material 2a | Yes |
| Material 2d | No |
| Material 3a | Yes |
| Material 3d | No |
| Material 4a | Yes |
| Material 4c | Yes |
| Material 4e | Yes |
| Material 5a | Yes |
| Material 5c | No |
| Material 6a | Yes |
| Material 6c | Yes |
| Material 7b | Yes |
| Material 8a | Yes |
| Material 9b | Yes |
| Material 10b | Yes |
| Material 11a | Yes |
| Material 12a | Yes |
| Material 13b | Yes |
| Material 14a | Yes |
| Material 15b | Yes |
| Material 16b | Yes |
| Material 17b | Yes |
| Material 18b | Yes |

### 1) Comparative Example

b) Filtration of a Standard Turbidity Solution

The filtration action is assessed in precoat filtration on the basis of clarification of a standard turbidity solution, that is a formazine solution of defined turbidity known to those skilled in the art for characterizing filter aids for the beverage industry.

The criteria of a good test result are constancy of flow rate and of precoat pressure and the filtration action, that is to say clarity of the filtrate:

the precoat pressure upstream and downstream of the filter, in the event of good flow through the filter, has the same value, that is to say the filter does not plug. Turbidity is determined by a standard EBC test (European Brewery Convention). A liquid is judged to be clear when the EBC turbidity values are <1.

Below, studies are described on the polymer samples described in section A. In this case, preferably, the grinding fraction having a particle size less than 100 μn is used.

The table shown below reports the values after passage of a volume of 5 l, 10 l and 15 l for selected samples.

Filtration action and flow through the filter

| | Sample | | | | |
|---|---|---|---|---|---|
| | 1c | 4d | 8b | 9b | 10b |
| EBC turbidity^{1) 2)} after passage | | | | | |
| of a volume of | | | | | |
| 5 l | 2.37 | 1.35 | 1.65 | 1.59 | 1.42 |
| 10 l | 1.38 | 1.19 | 1.18 | 1.23 | 1.07 |
| 15 l | 0.95 | 0.86 | 0.92 | 0.98 | 0.83 |
| Flow rate³⁾ (l h⁻¹) | 40⁴⁾ | 40⁴⁾ | 40⁴⁾ | 40⁴⁾ | 40⁴⁾ |
| Precoat pressure⁵⁾ (bar) (up- | 1.5⁴⁾/1.5⁴⁾ | 1.5⁴⁾/1.5⁴⁾ | 1.5⁴⁾/1.5⁴⁾ | 1.5⁴⁾/1.5⁴⁾ | 1.5⁴⁾/1.5⁴⁾ |
| stream/downstream of filter) | | | | | |
| | Sample | | | | |
| | 11c | 12b | 13a | 14b | 15b |
| EBC turbidity^{1) 2)} after passage | | | | | |
| of a volume of | | | | | |
| 5 l | 1.12 | 1.05 | 1.34 | 0.95 | 0.85 |
| 10 l | 0.84 | 0.76 | 1.13 | 0.76 | 0.69 |
| 15 l | 0.62 | 0.57 | 0.86 | 0.51 | 0.47 |
| Flow rate³⁾ (l h⁻¹) | 40⁴⁾ | 40⁴⁾ | 40⁴⁾ | 40⁴⁾ | 40⁴⁾ |
| Precoat pressure⁵⁾ (bar) | 1.5⁴⁾/1.5⁴⁾ | 1.5⁴⁾/1.5⁴⁾ | 1.5⁴⁾/1.5⁴⁾ | 1.5⁴⁾/1.5⁴⁾ | 1.5⁴⁾/1.5⁴⁾ |
| (upstream/downstream of filter) | | | | | |

| | Sample | | |
|---|---|---|---|
| | 16b | 17a | 18a |
| EBC turbidity^{1) 2)} after passage | | | |
| of a volume of | | | |
| 5 l | 0.86 | 0.75 | 0.72 |
| 10 l | 0.78 | 0.71 | 0.56 |
| 15 l | 0.51 | 0.46 | 0.39 |
| Flow rate³⁾ (l h⁻¹) | 40⁴⁾ | 40⁴⁾ | 40⁴⁾ |
| Precoat pressure⁵⁾ (bar) | 1.5⁴⁾/1.5⁴⁾ | 1.5⁴⁾/1.5⁴⁾ | 1.5⁴⁾/1.5⁴⁾ |
| (upstream/downstream of filter) | | | |

¹⁾EBC: European Brewery Convention.
²⁾The zero value, that is to say the value of the standard turbidity solution, is 20 EBC.
³⁾The flow rate without a filter aid is 40 l h⁻¹.
⁴⁾The measured value is constant during the entire filtration period.
⁵⁾The precoat pressure of the pure liquid, that is to say without filter aid, is 1.5 bar.

The stabilization experiments set forth below were carried out on selected examples. For these, in detail,, the following approaches were taken:

Prior to the analyses, the beer was degassed by stirring (decarbonation of the beer). The speed of rotation of the magnetic stirrer must be chosen so that no atmospheric oxygen is incorporated into the beer.

Adsorption Capacity of PVPP

Weigh out 20-100 mg of PVPP (based on dry matter).

Add 200 ml of decarbonated beer.

Contact time during stirring is exactly 5 minutes.

Filter off through a glass frit.

Use filtrate for determination of tannins and anthocyanogens.

Null bier (blank value) accordingly without addition of PVPP.

Experimental Procedure

Method for Determining Anthocyanogens

G. Harris, R. W. Ricketts: “Studies on non-biological haze . . . ”, J. Inst. Brew., Vol. 65, 331-333 (1959), MEBAK, Brautechn. Analysenmethoden [Brewing analysis methods], Vol. II, 3rd Edition, 171-172 (1993), Method corrected according to MEBAK decision of Apr. 22, 1999.

Anthocyanogens are determined photometrically by conversion to red anthocyanidins by hot hydrochloric acid.

Method for Determining Tannins

Tannometer, Pfeuffer (Haze Titration)

Tannin content of beer is determined by polyvinylpyrrolidone. Protein-like compounds are added to tannins via H bonds. As a result, owing to complexing, haze is formed. In the tannometer the haze is measured as a function of the amount of PVP added. The result gives tannin content in mg of PVP/1 of beer.

The adsorption capacity of PVPP [%] is given by the tannin values.

| | Anthocyanogens [mg/l] | Tannins [PVP/mg/l] |
|---|---|---|
| Null beer | 103.75 | 51.56 |
| 25 g/hl Ex. 4c | 75.88 | 41.3 |
| 50 g/hl Ex. 4c | 84.15 | 43.92 |
| 75 g/hl Ex. 4c | 68.97 | 30.99 |
| 100 g/hl Ex. 4c | 66.89 | 22.7 |
| 125 g/hl Ex. 4c | 58.58 | 23.55 |
| Divergan F 25 g/hl | 45.29 | 15.13 |
| Null beer | 85.43 | 45.08 |
| 25 g/hl Ex.4d | 81.26 | 43.31 |
| 50 g/hl Ex.4d | 75.99 | 36.31 |
| 75 g/hl Ex.4d | 71.24 | 33.17 |
| 100 g/hl Ex.4d | 75.64 | 30.85 |
| 125 g/hl Ex.4d | 70.23 | 31.18 |
| Divergan F 25 g/hl | 41.32 | 16.32 |

We claim:

1. The use of compounds comprising
a) 20-95% by weight of polystyrene
b) 80-5% by weight of crosslinked polyvinylpolypyrrolidone (PVPP), and optionally further added substances.
as filter aids and/or stabilizers for filtering and/or stabilizing an aqueous liquid.

2. The use of compounds as claimed in claim 1, wherein, in addition to the filtration, stabilization of the aqueous liquid takes place at the same time.

3. The use of compounds as claimed in either of claims 1 or 2, wherein the further substance set forth under (b) is selected from the group consisting of alkali metal carbonates or alkaline earth metal carbonates, alkali metal hydrogencarbonates or alkaline earth metal hydrogencarbonates, the oxides or mixed oxides of subgroup 4 or main group 3 of the Periodic Table of the Elements, polyamides, crosslinked polyvinyllactams, polyvinylamines or mixtures thereof.

4. The use of compounds as claimed in one of claims 1 to 3, wherein the further substance set forth under (b) is selected from the group consisting of crosslinked polyvinylpolypyrrolidone, TiO₂, NaHCO₃, KHCO₃, CaCO₃, silica gel, kieselguhr, diatomaceous earth, bentonite or mixtures thereof.

5. A process for filtering and/or stabilizing an aqueous liquid, which comprises using as filter aid or stabilizer a compound comprising
(a) 20-95% by weight of polystyrene
(b) 80-5% by weight of crosslinked polyvinylpolypyrrolidone (PVPP), and optionally further added substances.

6. The process as claimed in claim 5, wherein, in addition to the filtration, stabilization of the medium to be filtered takes place at the same time.

7. A process as claimed in one of claims 5 or 6, wherein the technique of precoat filtration is used in the filtration.

8. A process as claimed in one of claims 5 to 7, wherein the aqueous liquid is a liquid selected from the group consisting of fruit juice drinks or fermented beverages.

9. A process as claimed in one of claims 5 to 8, wherein the aqueous liquid is beer.

10. A process as claimed in one of claims 5 to 9, wherein the compounds used have a mean particle size from 1 to 1 000 μm.

11. A process as claimed in one of claims 5 to 10, wherein the particles of the compounds used are not spheroidal.

12. A compound comprising
(a) from 20 to 95% by weight of polystyrene
(b) 80-5% by weight of crosslinked polyvinylpolypyrrolidone (PVPP), and optionally further added substances.

13. A compound as claimed in claim 12, comprising
(a) 60-90% by weight of polystyrene
(b) 40-10% by weight of polyvinylpolypyrrolidone, and optionally a further added substance.

14. A filter aid comprising compounds as claimed in one of claims 12 or 13.

15. A stabilizer comprising compounds as claimed in one of claims 12 or 13.

16. A process for preparing compounds as claimed in one of claims 12 or 13, which comprises compounding polystyrene and polyvinylpolypyrrolidone in an extruder.
